(19) United States
(12) Patent Application Publication
(10) Pub. No.: US 2022/0225398 A1
(43) Pub. Date: Jul. 14, 2022

(54) TRANSMISSION MODE SWITCHING METHOD IN UNLICENSED CONTROLLED ENVIRONMENTS

(71) Applicant: INSTITUTE FOR INFORMATION INDUSTRY, TAIPEI CITY (TW)

(72) Inventor: Yen-Chih KUO, TAIPEI CITY (TW)

(21) Appl. No.: 17/535,953

(22) Filed: Nov. 26, 2021

Related U.S. Application Data
(60) Provisional application No. 63/136,652, filed on Jan. 13, 2021.

(51) Int. Cl. H04W 72/14; H04L 1/16; H04W 16/14

(52) U.S. Cl. CPC H04W 72/14; H04W 16/14; H04L 1/16

(57) ABSTRACT

The present disclosure provides a transmission mode switching method in unlicensed spectrum control environments (UCE). The transmission mode switching method is executed by a user equipment (UE). The UE can determine a number of failures of the data received by the gNB based on a DG signal and a number of the data successfully received by the gNB based on an acknowledgement signal. When the gNB fails to receive the data many times, the UE determines communication quality is bad, and the UE will switch to a first CG transmission mode to increase reliability for transmitting the data. When the gNB successfully receives the data many times, the UE determines that the communication quality is good, and the UE will switch to a second CG transmission mode to decrease latency of transmitting the data. Therefore, spectrum usage efficiency in the UCE can be improved.

### CROSS-REFERENCE TO RELATED APPLICATION

This application claims priority to U.S. Provisional Patent Application No. 63/136,652 filed on Jan. 13, 2021, which is hereby incorporated by reference in its entirety.

### BACKGROUND

### 1. Field of the Disclosure

The present disclosure relates to a transmission mode switching method, in particular to a transmission mode switching method in unlicensed spectrum control environments (UCE).

### 2. Description of the Prior Arts

In the fifth generation (5G) communication technology standard specifications, there are at least two transmission modes for a user equipment (UE) to transmit uplink radio signals to a next generation Node B (gNB). One of the transmission modes is the ultra-reliable and low latency communications configured grant mode (URLLC CG mode), and the other one of the transmission modes is the new radio unlicensed configured grant mode (NR-U CG mode).

URLLC CG mode is used in the licensed spectrum to solve the latency problem when the communication quality of the radio channel is good. The NR-U CG mode is used in the unlicensed spectrum to solve the reliability problem when the communication quality of the radio channel is bad.

However, the communication quality of the radio channel is constantly changing in unlicensed controlled environments (UCE). For example, unpredictable noise interference often decreases the communication quality of the radio channel. When there is no noise interference, the radio channel can maintain good communication quality. Therefore, if only a single transmission mode is used, it is easy to cause excessive latency or poor transmission reliability.

For example, if the UE transmits uplink radio signals to the gNB by the NR-U CG mode, when the communication quality of the radio channel is good without noise interference, the NR-U CG mode can maintain higher reliability but increase the latency.

If the UE transmits uplink radio signals to the gNB by the URLLC CG mode, when the communication quality of the radio channel becomes bad with noise interference, the URLLC CG mode can decrease the latency, but it can also reduce the reliability.

Therefore, the existing transmission method for the UE to transmit the uplink radio signals to the gNB still needs to be further improved.

### SUMMARY

In view of the above problems, the present disclosure provides a transmission mode switching method in unlicensed spectrum control environments. In environments where the communication quality of the radio channel may change, a user equipment (UE) automatically switches the transmission mode of transmitting uplink radio signals to a next generation Node B (gNB) based on the communication quality of the radio channel, thereby improving spectrum usage efficiency in unlicensed spectrum control environments (UCE).

A transmission mode switching method in the UCE is executed by the UE, and the transmission mode switching method includes steps of: transmitting a first data to a next generation Node B (gNB); determining whether a dynamic grant signal transmitted by the gNB is received; when the dynamic grant signal is received, triggering a first trigger unit and determining whether the first trigger unit satisfies a first condition; when the first trigger unit satisfies the first condition, configuring a configured grant retransmission timer, switching to a first configured grant transmission mode, and transmitting a first retransmission data to the gNB; when the first trigger unit does not satisfy the first condition, transmitting the first retransmission data to the gNB; and when the dynamic grant signal is not received, resetting the first trigger unit.

When the gNB receives a data from the UE, the gNB decodes the data. When the gNB cannot successfully decode the data, the gNB generates a dynamic grant (DG) signal and sends the DG signal to the UE. Therefore, when the UE receives the DG signal, it means that the gNB cannot successfully decode the data. That is, the UE does not successfully transmit the data to the gNB. At this time, the UE triggers the first trigger unit and determines whether the first trigger unit satisfies the first condition. When the UE determines that the first trigger unit satisfies the first condition, it means that the UE fails to transmit data to the gNB many times. Therefore, the communication quality of the current radio channel is determined to be bad, which causes the UE to fail to send data to the gNB many times. Therefore, when the first trigger unit satisfies the first condition, the UE switches to the first CG transmission mode, thereby improving the reliability of data transmission by the first CG transmission mode.

For example, the first CG transmission mode may be an NR-U CG mode used in an unlicensed spectrum. Therefore, when the communication quality is bad, the reliability of data transmission can be improved by the first CG transmission mode.

The transmission mode switching method in unlicensed spectrum control environments, executed by a UE, includes steps of: transmitting a third data to a gNB; resetting and starting a configured grant retransmission timer; determining whether the configured grant retransmission timer times out; when the configured grant retransmission timer times out, resetting a second trigger unit, and transmitting a second retransmission data to the gNB; when the configured grant retransmission timer does not time out, determining whether a downlink feedback information signal transmitted by the gNB is received; when receiving the downlink feedback information signal, determining whether the downlink feedback information signal is successfully decoded; when the downlink feedback information signal is successfully decoded, determining whether the downlink feedback information signal contains an acknowledgment signal; when the downlink feedback information signal includes the acknowledgment signal, triggering the second trigger unit, and determining whether the second trigger unit satisfies a second condition; and when the second trigger unit satisfies the second condition, deconfiguring the configured grant retransmission timer, and switching to a second configured grant transmission mode.

When the gNB can successfully decode the data transmitted by the UE, the gNB generates a downlink feedback information (DFI) signal and sends the DFI signal to the UE. Therefore, when the UE can receive the DFI signal, it means that the gNB can successfully decode the data, that is, the UE successfully transmits the data to the gNB. At this time, the UE further decodes the DFI signal and confirms whether the DFI signal contains an ACK signal. When the DFI signal contains the ACK signal, the UE triggers the second trigger unit and determines whether the second trigger unit satisfies the second condition. And when the UE determines that the second trigger unit satisfies the second condition, it means that the UE successfully transmits data to the gNB many times. Then it can be determined that the communication quality of the current radio channel should be better, so the UE can successfully transmit data to the gNB many times. In this way, when the second trigger unit satisfies the second condition, the UE switches to the second CG transmission mode, and the latency of data transmission can be decreased by the second CG transmission mode.

For example, the second CG transmission mode may be a URLLC CG mode. Therefore, when the communication quality is good, the latency of data transmission can be decreased by the second CG transmission mode.

In summary, the present disclosure can automatically switch the current CG transmission mode based on the communication quality of the radio channel. When the communication quality of the radio channel is good, the second CG transmission mode is automatically used. And when the communication quality of the radio channel is bad, the first CG transmission mode is used automatically. In this way, when the communication quality is good, the second CG transmission mode can be used to effectively decrease latency of transmission, and when the communication quality is bad, the first CG transmission mode can be used to improve the reliability, thereby improving spectrum usage efficiency in UCE

### BRIEF DESCRIPTION OF THE DRAWINGS

FIG. 1A is a schematic flowchart of a first embodiment of the transmission mode switching method in unlicensed spectrum control environments of the present disclosure.

FIG. 1B is a block diagram of a UE and a gNB.

FIG. 2 is a schematic flowchart of a second embodiment of the transmission mode switching method in unlicensed spectrum control environments of the present disclosure.

FIG. 3 is a schematic flowchart of a third embodiment of the transmission mode switching method in unlicensed spectrum control environments of the present disclosure.

FIG. 4 is a schematic flowchart of a fourth embodiment of the transmission mode switching method in unlicensed spectrum control environments of the present disclosure.

FIG. 5 is a schematic flowchart of a fifth embodiment of the transmission mode switching method in unlicensed spectrum control environments of the present disclosure.

FIG. 6 is a schematic flowchart of a sixth embodiment of the transmission mode switching method in unlicensed spectrum control environments of the present disclosure.

FIG. 7 is a schematic flowchart of a seventh embodiment of the transmission mode switching method in unlicensed spectrum control environments of the present disclosure.

FIG. 8A and FIG. 8B are a schematic flowchart of an eighth embodiment of the transmission mode switching method in unlicensed spectrum control environments of the present disclosure.

### DETAILED DESCRIPTION

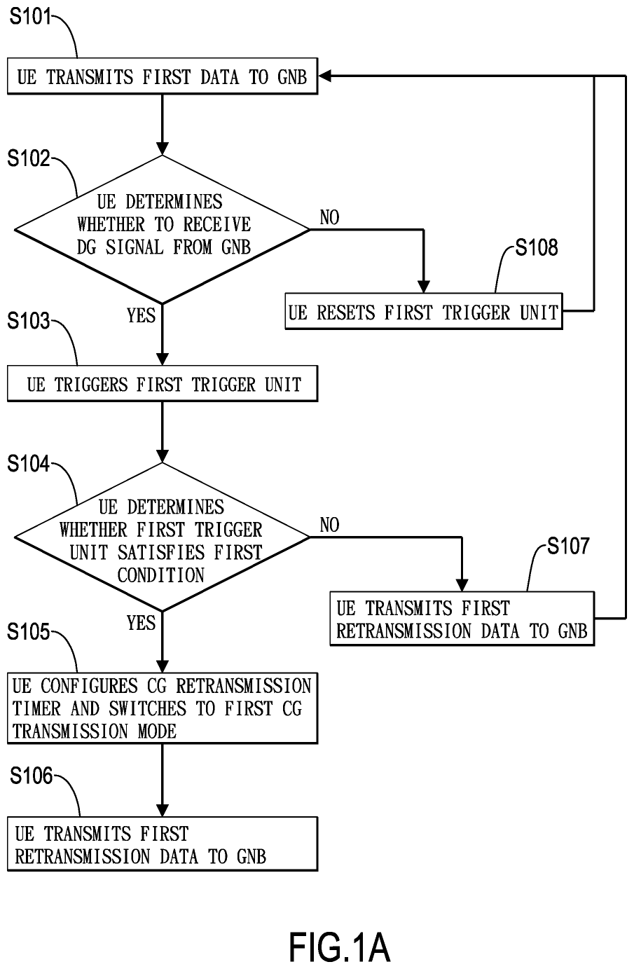

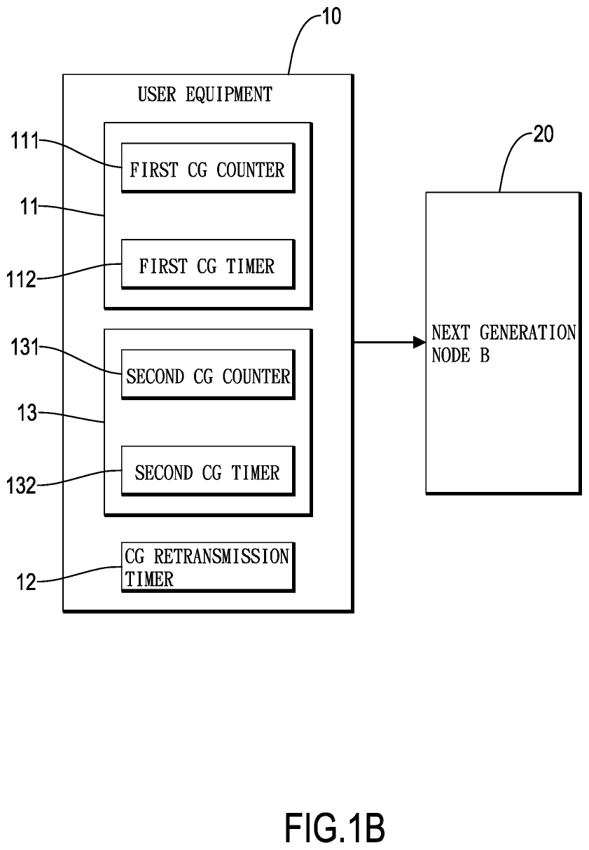

Referring to FIG. 1A and FIG. 1B, a transmission mode switching method in unlicensed spectrum control environments in FIG. 1A is executed by some or all of the components of the user equipment (UE) 10 in FIG. 1B.

In a first embodiment, the transmission mode switching method in unlicensed spectrum control environments includes steps S101 to S108.

In step S101, the UE 10 transmits a first data to a gNB 20. For example, the first data may be uplink data. In the fifth generation (5G) communication technology standard specifications, the data transmitted by the UE 10 to the gNB 20 is uplink data, and the data transmitted by the gNB 20 to the user equipment 10 is downlink data.

In step S102, the UE 10 determines whether to receive a dynamic grant (DG) signal from the gNB 20. When the gNB 20 fails to receive the data, the gNB 20 generates a DG signal and sends the DG signal to the UE 10. Therefore, when the UE 10 receives the DG signal, it means that the gNB 20 fails to receive the data, that is, the UE 10 fails to transmit the data, such as the Listen-Before-Talk failure (LBT failure). In other words, the UE 10 can determine whether the gNB 20 successfully receives and decodes the data transmitted by the UE 10 by receiving the DG signal from the gNB 20 or not.

In steps S103, S104 and S105, when the UE 10 receives the DG signal, the UE 10 triggers the first trigger unit 11 (S103), and determines whether the first trigger unit 11 satisfies the first condition (S104). When the first trigger unit 11 satisfies the first condition, the UE 10 configures the CG retransmission timer 12 and switches to the first CG transmission mode (S105).

In the first embodiment, referring to FIG. 1A, in S101, the current CG transmission mode between the UE 10 and the gNB 20 is the URLLC CG mode. After several steps in FIG. 1A, in S105, the CG transmission mode is switched to the first CG transmission mode. Wherein the first CG transmission mode is the NR-U CG mode.

In step S106, after switching to the first CG transmission mode, the UE 10 further transmits the first retransmission data to the gNB 20.

As the UE 10 has received the DG signal before switching to the first CG transmission mode, when the UE 10 receives the DG signal, it means that the previously transmitted first data has not been received by the gNB 20. Therefore, the UE 10 needs to transmit the first retransmission data to the gNB 20, thereby retransmitting the first data to the gNB 20.

In step S107, when the first trigger unit 11 does not meet the first condition, the UE 10 transmits the first retransmission data to the gNB 20.

When the first trigger unit 11 does not satisfy the first condition, it means that the UE 10 has not failed to transmit the first data to the gNB 20 multiple times in succession. However, the UE 10 still triggers the first trigger unit 11 after receiving the DG signal and determines whether the first trigger unit 11 satisfies the first condition. Therefore, when the first trigger unit 11 does not meet the first condition, the UE 10 still needs to transmit the first retransmission data to retransmit the first data to the gNB 20.

In step S108, when the DG signal is not received, the UE 10 resets the first trigger unit 11.

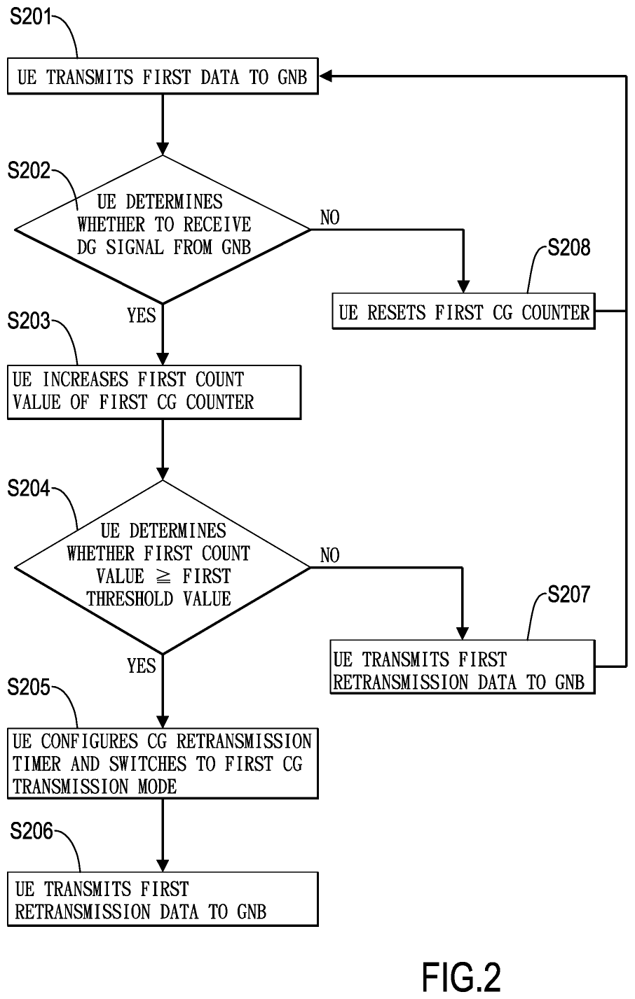

Referring to FIG. 2, in a second embodiment, the steps S201, S202, S205, S206, and S207 are the same as the steps S101, S102, S105, S106, and S107 of the aforementioned first embodiment, which is not repeated here. The second embodiment is different from the first embodiment in that the first trigger unit 11 is a first configuration grant (CG) counter 111.

In step S203, when the UE 10 triggers the first trigger unit 11, the first count value of the first CG counter 111 is increased, such as, increasing the first count value by one.

In step S204, the UE 10 determines whether the first trigger unit 11 satisfies the first condition by determining whether the first count value of the first CG counter 111 is greater than or equal to the first threshold value. And when the first count value is greater than or equal to the first threshold value, the UE 10 determines that the first trigger unit 11 satisfies the first condition.

In the second embodiment, the UE 10 increases the first count value of the first CG counter 111 only when receiving the DG signal representing transmission failure. In this way, the UE 10 can determine a number of consecutive failures to transmit data to the gNB 20 according to the first count value. And when the number of consecutive failures is greater than the first threshold, it means that the UE 10 has failed to transmit data many times. Therefore, the UE 10 can determine that the current communication quality is bad, further configures the CG retransmission timer 12, and switches to the first CG transmission mode to improve the reliability of signal transmission.

For example, when the first count value of the first CG counter 111 is greater than or equal to the first threshold value, it means that the UE 10 has continuously received the DG signal multiple times. That is, the number of consecutive data transmission failures is greater than or equal to the first threshold value, so the UE 10 will determine that the first condition meets the first condition, and then will switch to the first CG transmission mode.

In addition, the first trigger unit 11 is the first CG counter 111, as shown in step S208, and then the first trigger unit 11 is reset by resetting the first count value of the first CG counter 111 to zero.

Referring to the second embodiment in FIG. 2, in step S201, the current CG transmission mode between the UE 10 and the gNB 20 is the URLLC CG mode. After several steps of FIG. 2, in step S205, the UE 10 switches to the first CG transmission mode, wherein the first CG transmission mode is the NR-U CG mode.

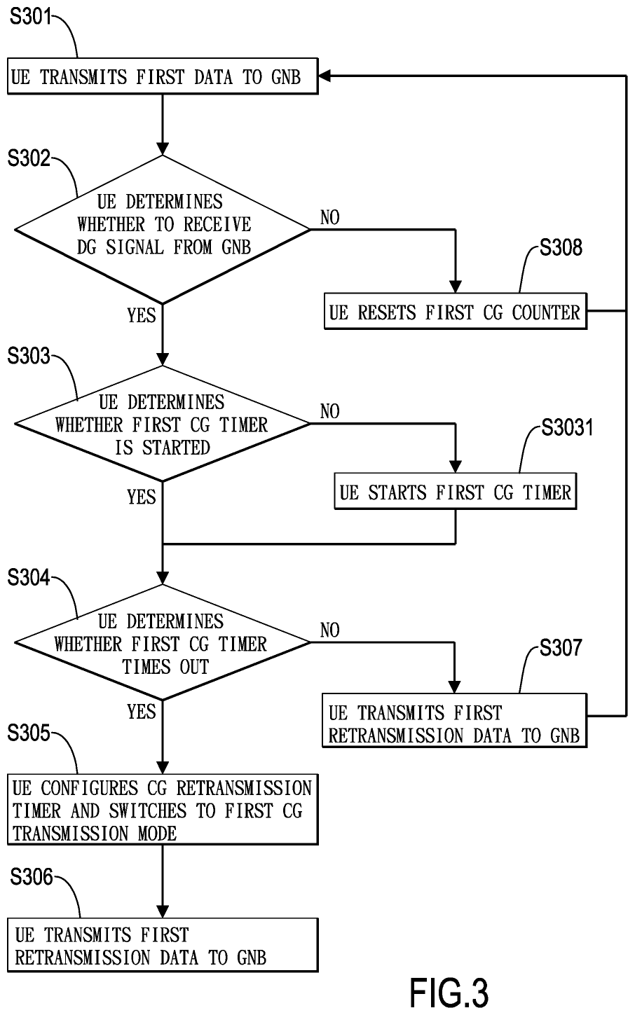

Referring to FIG. 3, in the third embodiment, the steps S301, S302, S305, S306, and S307 are the same as S101, S102, S105, S106, and S107, so the description thereof is not be repeated here. The third embodiment is different from the first embodiment in that the first trigger unit 11 is the first CG timer 112.

In step S303, the UE 10 triggers the first trigger unit 11 by determining whether the first CG timer 112 is started.

In steps S3031, S304, S305, when the first CG timer 112 is started, the UE 10 determines whether the first trigger unit 11 satisfies the first condition (S304). When the first CG timer 112 is not started, the UE 10 starts the first CG timer 112 (S3031) and then determines whether the first trigger unit 11 satisfies the first condition (S304). Wherein the UE 10 determines whether the first trigger unit 11 satisfies the first condition by determining whether the first CG timer 112 times out (S304), and when the first CG timer 112 times out, the UE 10 determines that the first trigger unit 11 satisfies the first condition.

In the third embodiment, the UE 10 determines whether the first CG timer 112 times out only when receiving a DG signal representing transmission failure. Therefore, the UE 10 confirms whether the DG signal is received continuously many times within the first time set by the first CG timer 112. If the first CG timer 112 times out, it means that the UE 10 has continuously received the DG signal many times within the first time, which means the transmission has failed many times. Therefore, the UE 10 can determine that the current communication quality is bad, then further configures the CG retransmission timer 12 and switches to the first CG transmission mode to improve the reliability of signal transmission.

For example, the first CG timer 112 is a countdown timer for confirming whether the first time is reached after the first CG timer 112 is started. For example, if the UE 10 continues to receive the DG signal within the first time after the first CG timer 112 is started, the UE 10 determines that the first CG timer 112 times out when receiving the DG signal again after the first timing value. That is, the first condition is met, and then the UE 10 switches to the first CG transmission mode.

In addition, as the first trigger unit 11 is a first CG timer 112, as shown in step S308, the UE 10 resets the first trigger unit by resetting the first time of the first CG timer 112.

In the third embodiment, referring to FIG. 3, in step S301, the current CG transmission mode between the UE 10 and the gNB 20 is the URLLC CG mode. Through the operation of FIG. 3, in S305, the UE 10 switches to the first CG transmission mode, wherein the first CG transmission mode is the NR-U CG mode.

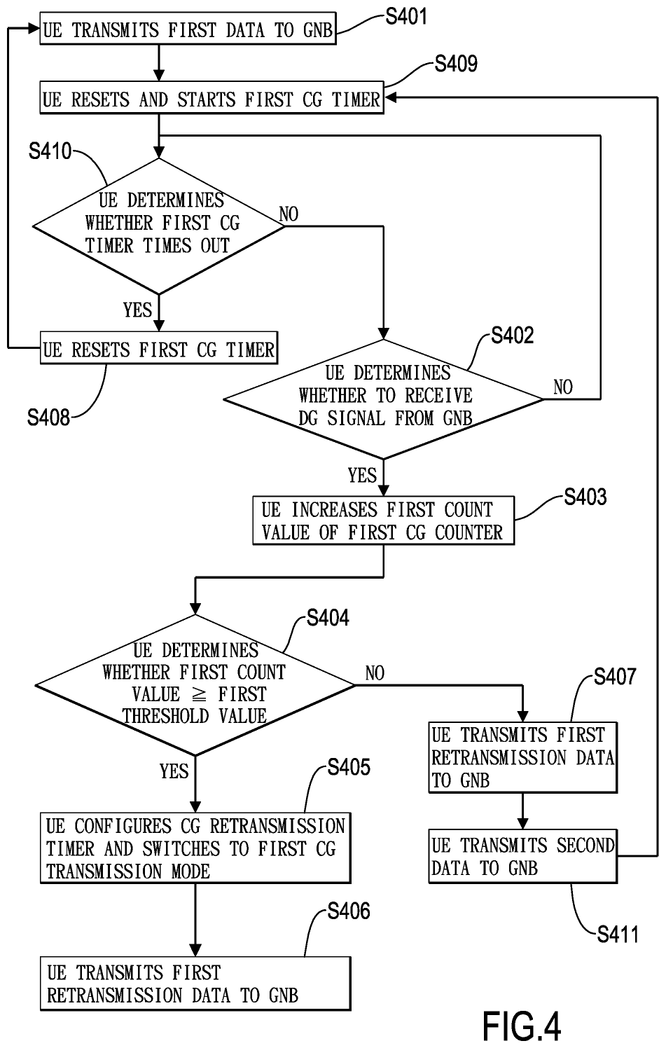

Referring to FIG. 4, in the fourth embodiment, the steps S401, S402, S405, S406, and S407 are the same as steps S101, S102, S105, S106, and S107, do description thereof will not be repeated here. The fourth embodiment is different from the first embodiment in that the first trigger unit 11 is a first CG counter 111.

After transmitting the first data to the gNB 20 (S401), the UE 10 first resets and starts the first CG timer 112 (S409), and determines whether the first CG timer 112 times out (S410). If the first CG timer 112 does not time out, the UE 10 determines whether to receive the DG signal from the gNB 20 (S402). If the first CG timer 112 times out, the UE 10 resets the first trigger unit 11 (S408). And when the DG signal is not received, the UE 10 first determines whether the first CG timer 112 times out (S410). If the first CG timer 112 times out, the UE 10 resets the first trigger unit 11 (S408).

In addition, in the fourth embodiment, the first CG counter 111 is similar to the first CG counter 111 in the third embodiment. The difference is that when the first CG counter 111 is less than the first threshold (that is, the first trigger unit 11 does not meet the first condition), the UE 10 transmits the first retransmission data to the gNB 20, and then further transmits the second data to the gNB 20, resets and starts the first CG timer 112 and determines whether the first CG timer 112 times out.

In the fourth embodiment, as the first CG timer 112 and the first CG counter 111 are in use, when the number of consecutively received DG signals within the first time is greater than the first threshold, the UE determines that the first condition is met, and switches to the first CG transmission mode.

For example, after the first CG timer 112 is started, if the number of DG signals continuously received by the UE 10 is greater than or equal to the first threshold within the first time, the UE 10 determines that the first condition is met, and then switches to the first CG transmission mode. However, if the number of the DG signals is less than the first threshold value within the first time, the UE 10 determines that the first CG timer 112 times out after the first time to reset the first CG counter 111.

In the fourth embodiment, referring to FIG. 4, in step S401, the current CG transmission mode between the UE 10 and the gNB 20 is the URLLC CG mode, and through the operation in FIG. 4, it is switched to the first CG transmission mode, wherein the first CG transmission mode is the NR-U CG mode.

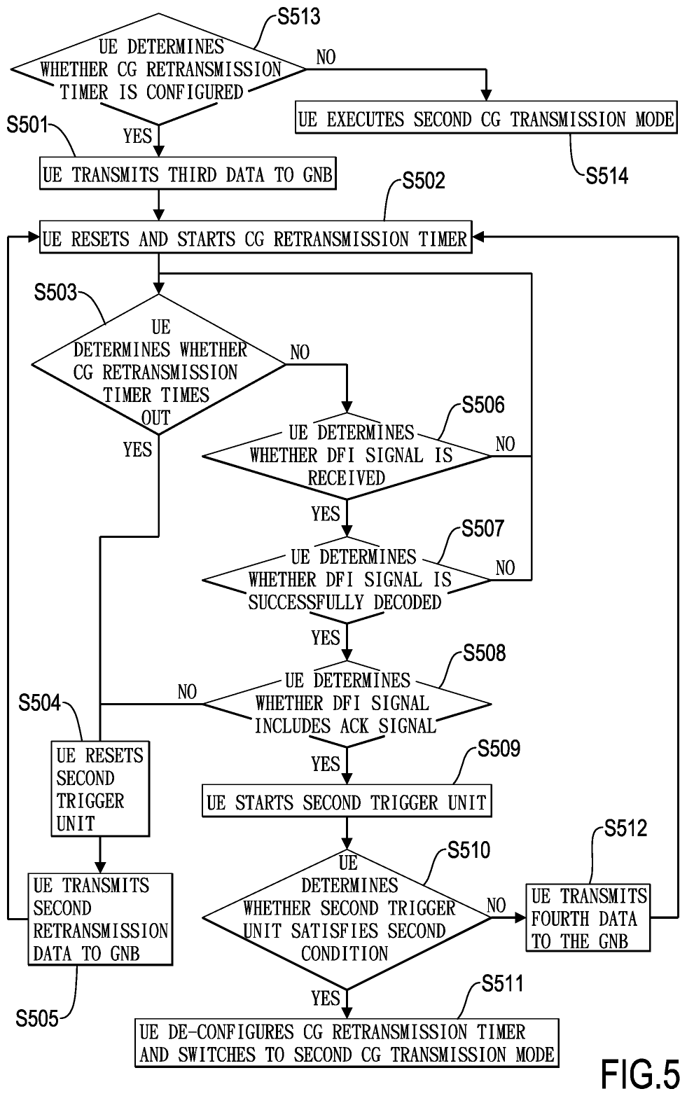

Referring to FIG. 5, in the fifth embodiment, the transmission mode switching method in unlicensed spectrum control environments includes steps S501 to S512.

In step S501, the UE 10 transmits the third data to the gNB 20. For example, the third data transmitted by the UE 10 is uplink data.

In step S502, the UE 10 resets and starts the CG retransmission timer 12. In the first CG transmission mode, the UE 10 confirms whether to retransmit data to the gNB 20 through the CG retransmission timer 12. Therefore, in the first CG transmission mode, the UE 10 needs to reset and start the CG retransmission timer 12.

In step S503, the UE 10 determines whether the CG retransmission timer 12 times out.

In step S504, if the CG retransmission timer 12 times out, the UE 10 resets the second trigger unit 13.

In step S505, the UE 10 transmits the second retransmission data to the gNB 20.

For example, if the CG retransmission timer 12 times out, it means that the UE 10 successfully receives the reception confirmation signal from the gNB 20 within the retransmission time of the CG retransmission timer 12. Therefore, if the CG retransmission timer 12 times out, the UE 10 resets the second trigger unit 13 and transmits the second retransmission data to retransmit the third data to the gNB 20. That is to say, if the CG retransmission timer 12 times out, it means that the gNB 20 fails to receive data. That is, the UE 10 fails to transmit data, such as the transmission mechanism of listening before speaking (LBT failure). The UE 10 can determine whether the gNB 20 successfully receives and decodes the data transmitted by the UE 10 by determining whether the CG retransmission timer 12 times out.

In step S506, when the CG retransmission timer 12 does not time out, the UE 10 determines whether the downlink feedback information (DFI) signal transmitted by the gNB 20 is received.

In step S507, when the UE 10 receives the DFI signal, the UE 10 determines whether the DFI signal is successfully decoded. However, when the UE 10 does not receive the DFI signal, the UE 10 determines whether the CG retransmission timer 12 times out (S503).

In step S508, when the UE 10 successfully decodes the DFI signal, the UE 10 determines whether the DFI signal includes an acknowledgement (ACK) signal. When the UE 10 fails to decode the DFI signal, the UE 10 determines whether the CG retransmission timer 12 times out (S503).

In step S509, when the DFI signal includes an ACK signal, the UE 10 starts the second trigger unit 13. However, when the DFI signal does not include the ACK signal, the UE 10 resets the second trigger unit 13 (S504), and transmits the second retransmission data to the gNB 20 (S505).

In steps S510, S511, S512, the UE 10 determines whether the second trigger unit 13 satisfies the second condition (S510). When the second trigger unit 13 meets the second condition, the UE 10 de-configures the CG retransmission timer 12 and switches to the second CG transmission mode (S511). But when the second trigger unit 13 does not meet the second condition, the UE 10 further transmits the fourth data to the gNB 20 (S512), resets and starts the CG retransmission timer 12 (S502), and then determines whether the CG retransmission timer 12 times out (S503).

Further, in the fifth embodiment, S513 and S514 are further included.

In steps S513 and S514, the UE 10 determines whether the CG retransmission timer 12 is configured. When the CG retransmission timer 12 is configured, the UE 10 transmits the third data to the gNB 20 (S501), and resets and starts the CG retransmission timer 12 (S502), and then determines whether the CG retransmission timer 12 times out. However, when the CG retransmission timer 12 is not configured, the UE 10 executes the second CG transmission mode.

In the fifth embodiment, referring to FIG. 5, in S501, the current CG transmission mode between the UE 10 and the gNB 20 is the NR-U CG mode. Through the operation of FIG. 5, in S511, the second CG transmission mode is switched, wherein the second CG transmission mode is the URLLC CG mode.

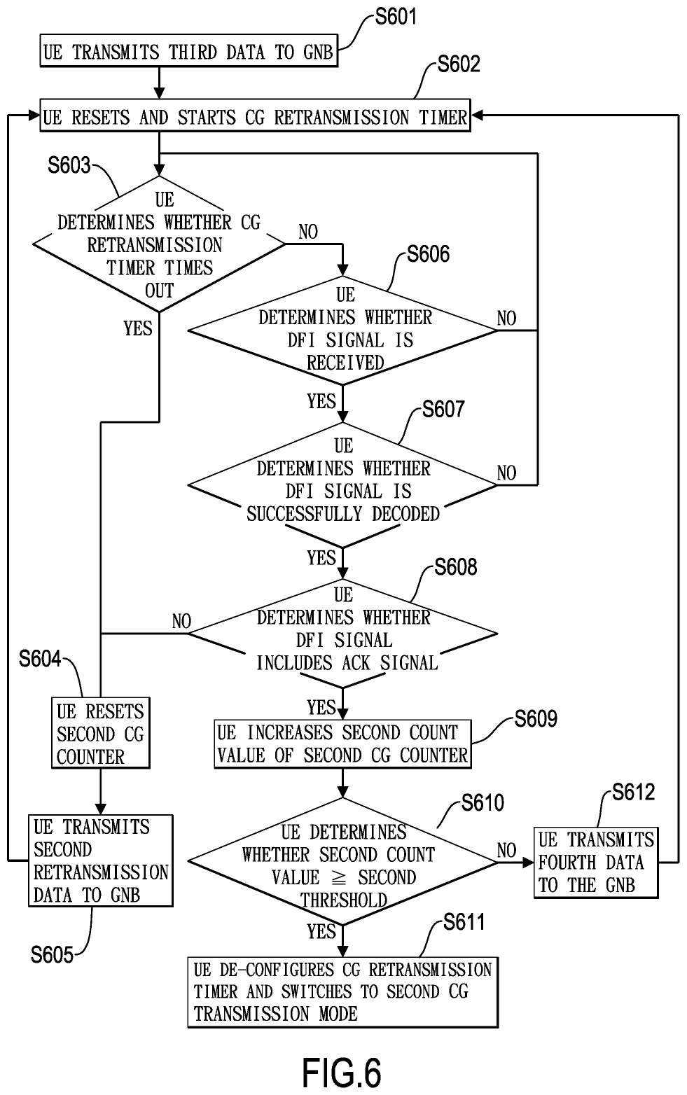

Referring to FIG. 6, in the sixth embodiment, steps S601 to S608 are the same as steps S501 to S508 of the foregoing fifth embodiment, so the description thereof is not be repeated here. The difference between the sixth embodiment and the fifth embodiment is that the second trigger unit 13 is a second CG counter 131.

In step S609, when the UE 10 triggers the second trigger unit 13, the second count value of the second CG counter 131 is increased, for example, increasing the second count value by one.

And as shown in steps S610, S611, and S612, the UE 10 determines whether the second trigger unit 13 satisfies the second condition by determining whether the second count value of the second CG counter 131 is greater than or equal to the first two thresholds (S610). And when the second count value is greater than or equal to the second threshold value, the UE 10 determines that the second trigger unit 13 satisfies the second condition, de-configures the CG retransmission timer 12, and switches to the second CG transmission mode (S611). However, when the second count value is less than the second threshold value, the UE 10 determines that the second trigger unit 13 does not meet the second condition, and the UE 10 further transmits the fourth data to the gNB 20 (S612), and resets and starts the CG retransmission timer 12 (S602), and then determines whether the CG retransmission timer 12 times out (S603).

In the sixth embodiment, the UE 10 successfully receives and decodes the DFI signal and determines that the DFI signal has an ACK signal, and the second count value of the second CG counter 131 is increased. Therefore, the UE 10 can confirm the number of ACK signals successfully received from the gNB 20 according to the second count value. And when the number of consecutively successfully received ACK signals is greater than the second threshold, it means that the gNB 20 successfully receives the data transmitted by the UE 10 many times. The UE 10 can determine that the current communication quality is better, and further deconfigures the CG retransmission timer 12, and switches to the second CG transmission mode to decrease transmission latency.

For example, when the second count value of the second CG counter 131 is greater than or equal to the second threshold value, it means that the UE 10 has continuously received the ACK signal multiple times, that is, the number of successful data transmissions is greater than or equal to the second threshold value, so the UE 10 determines that the second condition is met, and then switches to the second CG transmission mode.

In the sixth embodiment, referring to FIG. 6, in step S601, the current CG transmission mode between the UE 10 and the gNB 20 is the NR-U mode. Through the operation of FIG. 6, in step S611, the CG transmission mode is switched, wherein the second CG transmission mode is the URLLC CG mode.

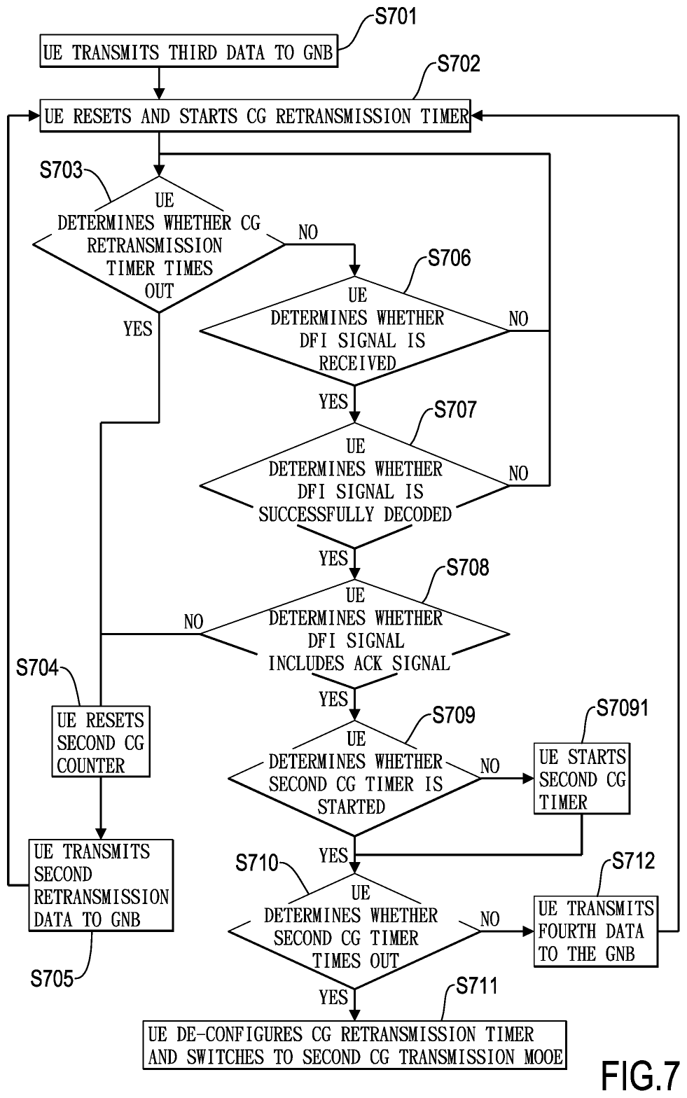

Referring to FIG. 7, in the seventh embodiment, the steps S701 to S708 are the same as steps S501 to S508 in the fifth embodiment, so the description thereof is not be repeated here. The difference between the seventh embodiment and the fifth embodiment is that the second trigger unit 13 is a second CG timer 132.

In step S709, when the UE 10 triggers the second trigger unit 13, it is determined whether the second CG timer 132 is started.

As shown in steps S7091, S710, and S711, when the second CG timer 132 starts, the UE 10 determines whether the second trigger unit 13 satisfies the second condition (S710). When the CG timer 132 is not started, the UE 10 first starts the second CG timer 132 (S7091), and then determines whether the second trigger unit 13 meets the second condition (S710). And the UE 10 determines whether the second trigger unit 13 satisfies the second condition by determining whether the second CG timer 132 expires (S710). If the second CG timer 132 times out, the UE 10 determines that the second trigger unit 13 satisfies the second condition.

In the seventh embodiment, the UE 10 starts and determines whether the second CG timer 132 times out only when confirming that the DFI signal has an ACK signal. Therefore, the UE 10 determines whether the ACK signal is received continuously multiple times within the second timing value set by the second CG timer 132. When the second CG timer 132 times out, it means that the UE 10 continuously receives the ACK signal multiple times within the second timing value. That is, the data has been successfully transmitted to the gNB 20 multiple times. Then the UE 10 can determine the current communication quality is better, then deconfigures the CG retransmission timer 12, and switches to the second CG transmission mode to decrease latency of signal transmission.

For example, the second CG timer 132 is a countdown timer for confirming whether to reach the second timing value after the second timer is started. For example, after the second CG timer 132 is started, if the UE 10 continually receives the ACK signal within the second timing value, when receiving the ACK signal again after the second timing value, the UE 10 determines that the second CG timer 132 times out and the second condition is met, and then switches to the second CG transmission mode.

In the seventh embodiment, referring to FIG. 7, in step S701, the current CG transmission mode between the UE 10 and the gNB 20 is the NR-U CG mode. Through the operation of FIG. 7, in step S711, it is switched to the second CG transmission mode, wherein the second CG transmission mode is the URLLC CG mode.

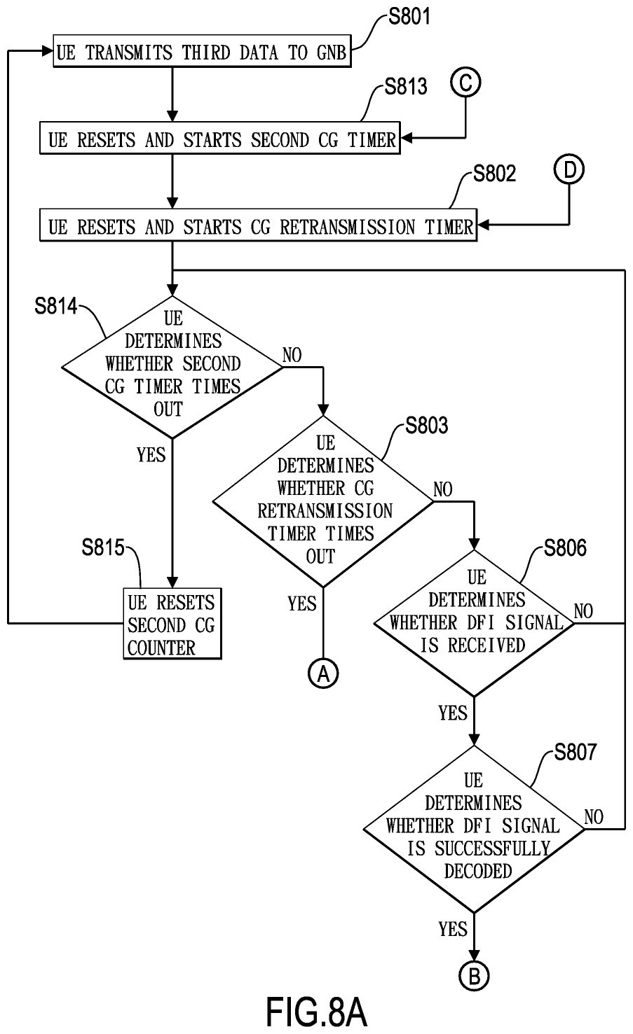

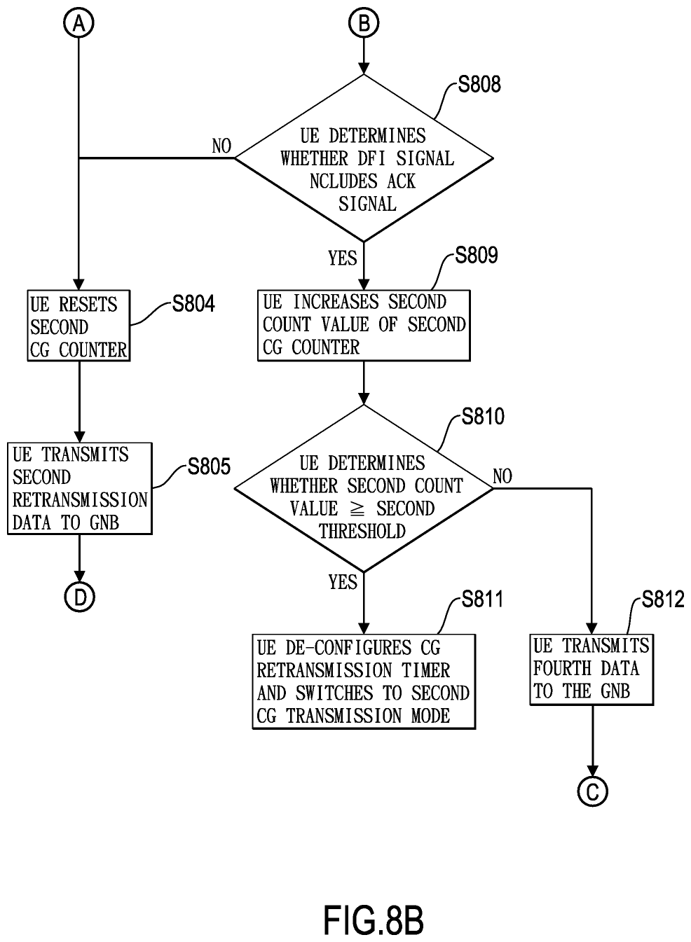

Referring to FIG. 8A and FIG. 8B, in the eighth embodiment, steps S801 to S808 are the same as steps S501 to S508 in the fifth embodiment, so the description thereof is not repeated here. The difference between the eighth embodiment and the fifth embodiment is that the second trigger unit 13 is a second CG counter 131.

And as shown in steps S812, S813, S814, and S815, when the UE 10 transmits the third data to the gNB 20 (S801), the UE 10 first resets and starts the second CG timer 132 (S813), resets and starts the CG retransmission timer 12 (S802), and the further determines whether the second CG timer 132 times out (S814). If the second CG timer 132 does not time out, the UE 10 determines whether the CG retransmission timer 12 times out (S803). However, if the second CG timer 132 times out, the UE 10 resets the second CG counter 131 (S815).

In addition, in the eighth embodiment, the operation of the second CG counter 131 is similar to that of the second CG counter 131 in the sixth embodiment. The difference is that when the second CG counter 131 is less than the second threshold, that is, when the second trigger unit 13 does not meet the second condition, the UE 10 resets and starts the second CG timer 132 (S813) after transmitting the fourth data to the gNB 20 (S812), and then resets and starts the CG retransmission timer 12 (S802).

For example, the CG retransmission timer 12 and the second CG timer 132 are both countdown timers, and the CG retransmission timer 12 is used to confirm whether to reach the retransmission time after the CG retransmission timer 12 is started. And the second CG timer 132 is used to confirm whether to reach the second time after the second timer is started.

For example, after the second CG timer 132 is started, if the number of ACK signals continuously received by the UE 10 within the second time is greater than or equal to the second threshold, the UE 10 determines that the second condition is met, and then switches to the second CG transmission mode. However, if the number of ACK signals consecutively received within the second time is less than the second threshold value, the UE 10 determines that the second CG timer 132 times out after the second time expires to reset the second counter. And if the second CG timer 132 does not expire, the UE 10 still needs to confirm whether to receive the ACK signal within the retransmission time of the CG retransmission timer 12 (S806 to S808). If the ACK signal cannot be confirmed within the retransmission time, the UE 10 determines that the CG retransmission timer 12 times out, resets the second CG counter 131, and transmits the second retransmission data to the gNB 20.

In the eighth embodiment, referring to FIG. 8, in step S801, the current CG transmission mode between the UE 10 and the gNB 20 is the NR-U CG mode. Through the operation of FIG. 8, in step S811, the second CG transmission mode is switched, wherein the second CG transmission mode is the URLLC CG mode.

In summary, the transmission mode switching method in unlicensed spectrum control environments of the present disclosure switches to the first CG transmission mode (for example, the NR-U CG mode), as shown in any one of the first to fourth embodiments. And it switches to the second CG transmission mode (for example, URLLC CG mode), as shown in any one of the fifth to eighth embodiments. The present disclosure can automatically switch the current CG transmission mode according to the communication quality of the radio channel. When the communication quality of the radio channel is good, the second CG transmission mode is automatically switched, and when the communication quality of the radio channel is poor, the second CG transmission mode is automatically switched. In this way, when the communication quality is good, the second CG transmission mode can effectively decrease latency, and when the communication quality is poor, the first CG transmission mode can improve the reliability. Therefore, the present disclosure dynamically evaluates the channel state to automatically switch to the best transmission mode, thereby improving the spectrum usage efficiency in the unlicensed spectrum control environments.

Even though numerous characteristics and advantages of the present disclosure have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A transmission mode switching method in unlicensed spectrum control environments, executed by a user equipment, wherein the transmission mode switching method comprises steps of:
transmitting a first data to a next generation Node B(gNB);
determining whether a dynamic grant signal transmitted by the gNB is received;
when the dynamic grant signal is received, triggering a first trigger unit and determining whether the first trigger unit satisfies a first condition;
when the first trigger unit satisfies the first condition, configuring a configured grant retransmission timer, switching to a first configured grant transmission mode, and transmitting a first retransmission data to the gNB;
when the first trigger unit does not satisfy the first condition, transmitting the first retransmission data to the gNB; and
when the dynamic grant signal is not received, resetting the first trigger unit.

2. The transmission mode switching method in the unlicensed spectrum control environments as claimed in claim 1, wherein the first trigger unit is a first configured grant counter;
wherein when the first trigger unit is triggered, a first count value of the first configured grant counter is increased;
wherein the step of determining whether the first trigger unit satisfies the first condition includes sub-steps of:
determining whether the first count value of the first configured grant counter is greater than or equal to a first threshold value;
when the first count value is greater than or equal to the first threshold value, determining that the first trigger unit satisfies the first condition; and
when the first count value is less than the first threshold value, determining that the first trigger unit does not satisfy the first condition.

3. The transmission mode switching method in the unlicensed spectrum control environments as claimed in claim 1, wherein the first trigger unit is a first configured grant timer;
wherein the step of triggering the first trigger unit includes sub-steps of:
determining whether the first configured grant timer is started; when the first configured grant timer starts, determining whether the first trigger unit satisfies the first condition; when the first configured grant timer is not started, starting the first configured grant timer first, and then determining whether the first trigger unit satisfies the first condition;
wherein the step of determining whether the first trigger unit satisfies includes sub-steps of:
determining whether the first configured grant timer times out;
when the first configured grant timer times out, determining that the first trigger unit satisfies the first condition; and
when the first configured grant timer does not time out, determining that the first trigger unit does not satisfy the first condition.

4. The transmission mode switching method in the unlicensed spectrum control environments as claimed in claim 1, further comprising steps of:
after the first data is transmitted to the gNB, resetting and starting a first configured grant timer, and determining whether the first configured grant timer times out;
when the first configured grant timer times out, resetting the first trigger unit;
when the first configured grant timer does not time out, determining whether the dynamic grant signal transmitted by the gNB is received;
when the dynamic grant signal is not received, determining whether the first configured grant timer times out;
when the first configured grant timer times out, resetting the first trigger unit;
wherein the first trigger unit is a first configured grant counter;
wherein when the first trigger unit is triggered, a first count value of the first configured grant counter is increased;
wherein the step of determining whether the first trigger unit satisfies the first condition includes sub-steps of:
determining whether the first count value of the first configured grant counter is greater than or equal to a first threshold value;
when the first count value is greater than or equal to the first threshold value, determining that the first trigger unit satisfies the first condition; and
when the first count value is less than the first threshold value, determining that the first trigger unit does not satisfy the first condition.

5. The transmission mode switching method in the unlicensed spectrum control environments as claimed in claim 4, wherein after the first trigger unit does not satisfy the first condition and the first retransmission data is transmitted to the gNB, the transmission mode switching method further comprises steps of:
transmitting a second data to the gNB;
resetting and activating the first configured grant timer; and
determining whether the first configured grant timer times out.

6. A transmission mode switching method in unlicensed spectrum control environments, executed by a user equipment, wherein the transmission mode switching method comprises steps of:
transmitting a third data to a gNB;
resetting and starting a configured grant retransmission timer;
determining whether the configured grant retransmission timer times out;
when the configured grant retransmission timer times out, resetting a second trigger unit, and transmitting a second retransmission data to the gNB;
when the configured grant retransmission timer does not time out, determining whether a downlink feedback information signal transmitted by the gNB is received;
when receiving the downlink feedback information signal, determining whether the downlink feedback information signal is successfully decoded;
when the downlink feedback information signal is successfully decoded, determining whether the downlink feedback information signal contains an acknowledgment signal;
when the downlink feedback information signal includes the acknowledgment signal, triggering the second trigger unit, and determining whether the second trigger unit satisfies a second condition; and
when the second trigger unit satisfies the second condition, deconfiguring the configured grant retransmission timer, and switching to a second configured grant transmission mode.

7. The transmission mode switching method in the unlicensed spectrum control environments as claimed in claim 6, further comprising steps of:
when the second trigger unit does not satisfy the second condition, further transmitting a fourth data to the gNB, resetting and starting the configuration authorized retransmission timer, and then determining whether the configured grant retransmission timer times out.

8. The transmission mode switching method in the unlicensed spectrum control environments as claimed in claim 7, further comprising steps of:
when the downlink feedback information signal does not include the acknowledgment signal, resetting the second trigger unit, and transmitting the second retransmission data to the gNB.

9. The transmission mode switching method in the unlicensed spectrum control environments as claimed in claim 8, further comprising steps of:
when the downlink feedback information signal is not successfully decoded, determining whether the configured grant retransmission timer times out.

10. The transmission mode switching method in the unlicensed spectrum control environments as claimed in claim 9, further comprising steps of:
when the downlink feedback information signal is not received, determining whether the configured grant retransmission timer times out.

11. The transmission mode switching method in the unlicensed spectrum control environments as claimed in claim 6, wherein the second trigger unit is a second configured grant counter;
wherein when the second trigger unit is triggered, a second count value of the second configured grant counter is increased;
wherein the step of determining whether the second trigger unit satisfies the second condition further includes sub-steps of:
determining whether the second count value of the second configured grant counter is greater than or equal to a second threshold value;
when the second count value is greater than or equal to the second threshold value, determining that the second trigger unit satisfies the second condition; and
when the second count value is less than the second threshold value, determining that the second trigger unit does not satisfy the second condition.

12. The transmission mode switching method in the unlicensed spectrum control environments as claimed in claim 6, wherein the second trigger unit is a second configured grant timer;
wherein after the second trigger unit is triggered, determining whether the second configured grant timer is started; when the second configured grant timer starts, determining whether the second trigger unit satisfies the second condition; when the second configured grant timer is not started, starting the second configured grant timer second and then determining whether the second trigger unit satisfies the second condition;
wherein the step of determining whether the second trigger unit satisfies the second condition includes sub-steps of:
determining whether the second configured grant timer times out;
when the second configured grant timer times out, determining that the second trigger unit satisfies the second condition; and
when the second configured grant timer does not time out, determining that the second trigger unit does not satisfy the second condition.

13. The transmission mode switching method in the unlicensed spectrum control environments as claimed in claim 6, further comprising steps of:
after transmitting the third data to the gNB, resetting and starting a second configured grant timer, resetting and starting the configured grant retransmission timer, and determining whether the second configured grant timer times out;
when the second configured grant timer times out, resetting the second trigger unit;
when the second configured grant timer does not time out, determining whether the configured grant retransmission timer times out;
when the downlink feedback information signal is not successfully decoded, determining whether the second configured grant timer times out; when the second configured grant timer does not time out, determining whether the configured grant retransmission timer times out;
when the downlink feedback information signal is not received, determining whether the second configured grant timer times out; when the second configured grant timer does not time out, determining whether the configured grant retransmission timer times out;
wherein the second trigger unit is a second configured grant counter;
wherein when the second trigger unit is triggered, a second count value of the second configured grant counter is increased;
wherein the step of determining whether the second trigger unit satisfies the second condition further includes sub-steps of:
determining whether the second count value of the second configured grant counter is greater than or equal to a second threshold value;
when the second count value is greater than or equal to the second threshold value, determining that the second trigger unit satisfies the second condition;
when the second count value is less than the second threshold value, determining that the second trigger unit does not satisfy the second condition;
wherein after the second retransmission data is transmitted to the gNB, resetting and starting the configured grant retransmission timer, and determining whether the second configured grant timer times out.

14. The transmission mode switching method in the unlicensed spectrum control environments as claimed in claim 13, wherein when the second trigger unit does not satisfy the second condition, transmitting a fourth data to the gNB, resetting and starting the second configured grant timer, resetting and starting the configured grant retransmission timing, and determining whether the second configured grant timer times out.

15. The transmission mode switching method in the unlicensed spectrum control environments as claimed in claim 6, further comprising steps of:
determining whether the configured grant retransmission timer is configured; and
when the configured grant retransmission timer is configured, transmitting the third data to the gNB, resetting and starting the configured grant retransmission timer, and determining whether the configured grant retransmission timer times out.

16. The transmission mode switching method in the unlicensed spectrum control environments as claimed in claim 15, wherein when the configured grant retransmission timer is not configured, the second configured grant transmission mode is executed, and the second configured grant transmission mode includes steps of:
transmitting a first data to the gNB;
determining whether a dynamic grant signal transmitted by the gNB is received;
when the dynamic grant signal is received, triggering a first trigger unit, and determining whether the first trigger unit satisfies a first condition;
when the first trigger unit satisfies the first condition, configuring a configured grant retransmission timer, switching to a first configured grant transmission mode, and transmitting a first retransmission data to the gNB, wherein the first configured grant transmission mode is different from the second configured grant transmission mode;
when the first trigger unit does not satisfy the first condition, transmitting the first retransmission data to the gNB; and
when the dynamic grant signal is not received, resetting the first trigger unit.

17. The transmission mode switching method in the unlicensed spectrum control environments as claimed in claim 16, wherein the first trigger unit is a first configured grant counter;
wherein when the first trigger unit is triggered, a first count value of the first configured grant counter is increased;
wherein the step of determining whether the first trigger unit satisfies the first condition includes sub-steps of:
determining whether the first count value of the first configured grant counter is greater than or equal to a first threshold value;
when the first count value is greater than or equal to the first threshold value, determining that the first trigger unit satisfies the first condition; and
when the first count value is less than the first threshold value, determining that the first trigger unit does not satisfy the first condition.

18. The transmission mode switching method in the unlicensed spectrum control environments as claimed in claim 16, wherein the first trigger unit is a first configured grant timer;
wherein the step of triggering the first trigger unit includes sub-steps of:
determining whether the first configured grant timer is started; when the first configured grant timer starts, determining whether the first trigger unit satisfies the first condition; when the first configured grant timer is not started, starting the first configured grant timer and then determining whether the first trigger unit satisfies the first condition;
wherein the step of determining whether the first trigger unit satisfies the first condition includes sub-steps of:
determining whether the first configured grant timer times out;
when the first configured grant timer times out, determining that the first trigger unit satisfies the first condition; and
when the first configured grant timer does not time out, determining that the first trigger unit does not satisfy the first condition.

19. The transmission mode switching method in the unlicensed spectrum control environments as claimed in claim 16, further comprising steps of:
after the first data is transmitted to the gNB, resetting and starting a first configured grant timer, and determining whether the first configured grant timer times out;
when the first configured grant timer times out, resetting the first trigger unit;
when the first configured grant timer does not time out, determining whether the dynamic grant signal transmitted by the gNB is received;
when the dynamic grant signal is not received, determining whether the first configured grant timer times out;
when the first configured grant timer times out, resetting the first trigger unit;
wherein the first trigger unit is a first configured grant counter;
wherein when the first trigger unit is triggered, a first count value of the first configured grant counter is increased;
wherein the step of determining whether the first trigger unit satisfies the first condition further includes sub-steps of:
determining whether the first count value of the first configured grant counter is greater than or equal to a first threshold value;
when the first count value is greater than or equal to the first threshold value, determining that the first trigger unit satisfies the first condition; and
when the first count value is less than the first threshold value, determining that the first trigger unit does not satisfy the first condition.

20. The transmission mode switching method in the unlicensed spectrum control environments as claimed in claim 19, wherein after the first trigger unit does not satisfy the first condition and the first retransmission data is transmitted to the gNB, the transmission mode switching method further comprises steps of:
transmitting a second data to the gNB;
resetting and activating the first configured grant timer; and
determining whether the first configured grant timer times out.
